(19) United States
(12) Patent Application Publication
(10) Pub. No.: US 2020/0118225 A1
(43) Pub. Date: Apr. 16, 2020

(54) USING VEHICLE LOCATION TO PROCESS ORDERS RECEIVED OVER WIRELESS COMMUNICATION

(71) Applicant: TOYOTA MOTOR NORTH AMERICA, INC., Plano, TX (US)

(72) Inventors: Ashok Ramadass, Plano, TX (US); Michael C. Edwards, McKinney, TX (US)

(21) Appl. No.: 16/157,817

(22) Filed: Oct. 11, 2018

(51) Int. Cl. G06Q 50/12; H04W 4/02; H04W 4/44; G06Q 10/06

(52) U.S. Cl. CPC G06Q 50/12; G06Q 10/06316; H04W 4/44; H04W 4/023

(57) ABSTRACT

According to one example, a method performed by a computing system includes receiving, via a transponder, a first order over a first wireless connection to a first device associated with a first vehicle. The method further includes determining a first distance between the transponder and the first device. The method further includes receiving, via the transponder, a second order over a second wireless connection to a second device associated with a second vehicle. The method further includes determining a second distance between the transponder and the second device. The method further includes placing the first order before the second order in a queue based on a comparison between the first distance and the second distance.

### FIELD OF THE DISCLOSURE

The present disclosure generally relates to methods and systems for using detected vehicle location to process orders received over wireless communication.

### BACKGROUND

Drive-thru pickup lines are common in various industries, particularly the food industry. Many businesses such as restaurants offer customers a drive-thru pickup option so that customers can remain in their vehicles while picking up their food. Typically, the driver pulls up to a first point, rolls down the window, and converses with a restaurant employee to make an order. Then, the drive pulls forward to a pickup window, at which point the ordered food is picked up. Other businesses, such as dry cleaning or pharmacies also use a pickup window to provide convenience to customers. It is desirable to provide further convenience to customers while using such pickup windows.

### SUMMARY

According to one example, a method performed by a computing system includes receiving, via a transponder, a first order over a first wireless connection to a first device associated with a first vehicle. The method further includes determining a first distance between the transponder and the first device. The method further includes receiving, via the transponder, a second order over a second wireless connection to a second device associated with a second vehicle. The method further includes determining a second distance between the transponder and the second device. The method further includes placing the first order before the second order in a queue based on a comparison between the first distance and the second distance.

According to one example, a method performed by a computing system includes receiving a first order from a first device associated with a first vehicle. The method further includes receiving a second order from a second device associated with a second vehicle. The method further includes prioritizing the first order over the second order based on a location of the first device determined from a first wireless connection between a transponder and the first device with respect to a location of the second device determined from a second wireless connection between the transponder and the second device.

According to one example, a system includes a processor and a memory comprising machine readable instructions that when executed by the processor, cause the system to transmit, over wireless connections, data to a plurality of computing devices, each of the plurality of computing devices associated with a different one of a plurality of vehicles. The system is further to receive, from the plurality of computing devices, a plurality of orders, each of the plurality of orders being for a specific one of the plurality of vehicles. The system is further to use the wireless connections to determine locations of each of the computing devices. The system is further to queue the orders based on the locations of each of the computing devices such that orders associated with vehicles closer to a pickup location are placed before orders associated with vehicles farther from the pickup location.

Another aspect of the present disclosure provides a non-transitory computer-readable medium having stored thereon machine-readable instructions executable by a computer to cause a machine to perform any of the methods described herein.

### BRIEF DESCRIPTION OF THE DRAWINGS

FIG. 1A is a diagram depicting wireless communication between a transponder and vehicles in a drive-thru line, according to one example of principles described herein.

FIG. 1B is a diagram depicting wireless communication between a transponder and vehicles in the drive-thru line with the transponder in a different location, according to one example of principles described herein.

FIG. 1C is a diagram depicting wireless communication between a transponder and vehicles in multiple drive-thru lines for a single pickup location, according to one example of principles described herein.

FIG. 1D is a diagram depicting wireless communication between a transponder and vehicles in multiple drive-thru lines for multiple pickup locations, according to one example of principles described herein.

FIG. 2 is a set of tables illustrating the prioritization of orders based on vehicle location, according to one example of principles described herein.

FIG. 3 is a flowchart showing an illustrative method for processing orders for vehicles in a drive-thru pickup line, according to one example of principles described herein.

FIG. 4 is a flowchart showing an illustrative method for processing orders for vehicles in a drive-thru pickup line, according to one example of principles described herein.

FIG. 5 is a diagram showing an illustrative computing system that may be used in accordance with principles described herein.

### DESCRIPTION OF ILLUSTRATIVE EMBODIMENTS

Illustrative embodiments and related methods of the present disclosure are described below as they might be employed in a system and method for vehicle audio setting configuration. In the interest of clarity, not all features of an actual implementation or method are described in this specification. It will of course be appreciated that in the development of any such actual embodiment described in the specification, numerous implementation specific decisions may be made to achieve the developers' specific goals, such as compliance with system-related and business-related constraints, which will vary from one implementation to another. Moreover, it will be appreciated that such a development effort would be an achievable undertaking for those of ordinary skill in the art having the benefit of this disclosure. Further aspects and advantages of the various embodiments and related methods of the disclosure will become apparent from consideration of the following description and drawings.

As mentioned above, various businesses use a pickup window to provide convenience to customers. It is desirable to provide further convenience to customers while using such pickup windows.

According to principles described herein, businesses may offer customers the ability to place orders remotely with either their vehicle's onboard computing system, or a mobile computing device such as a smart phone. For example, as a driver pulls into the drive-thru line, he or she may use an application on the onboard vehicle computing system to place an order. Thus, the customer does not have to roll down the window and converse with an employee of the business to make an order. The order may be transmitted from the vehicle to the business using a wireless connection, such as Bluetooth, Bluetooth Low Energy (LE), Wi-Fi, Wi-Fi direct, Near-Field Communications (NFC), or Ultrawide Band (UWB).

Because the business may receive multiple orders from multiple vehicles in the drive-thru line, it may be important to determine which vehicles are closer to the pickup window than others. This allows the business to prioritize the orders from the closer vehicles. In other words, the business can process the orders for the vehicles in the order in which the vehicles are in the drive-thru line.

According to principles described herein, a computing system associated with the business may utilize the wireless connections over which the orders are transmitted to determine approximate vehicle locations. Thus, the order in which the vehicles are in the drive-thru line may be determined. With this information, the business may prioritize the orders for the vehicles that are closer to the pickup window.

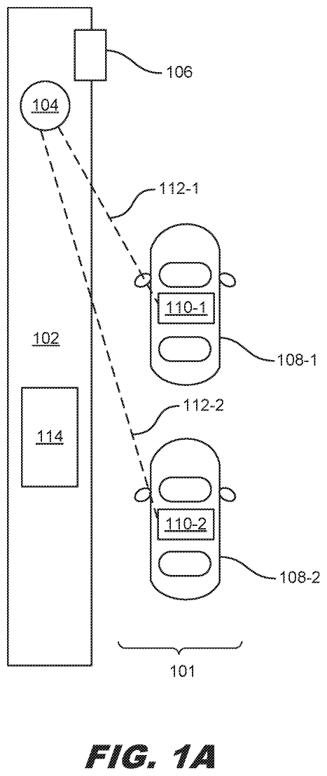

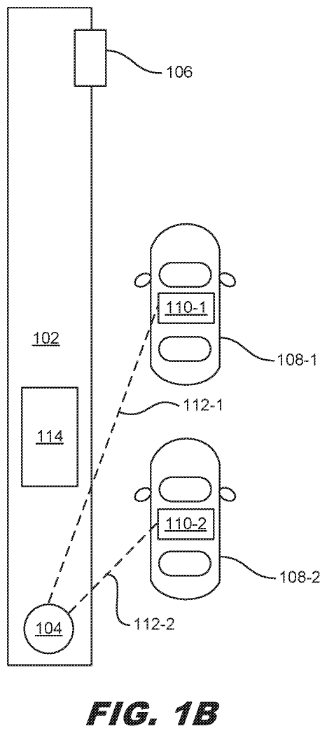

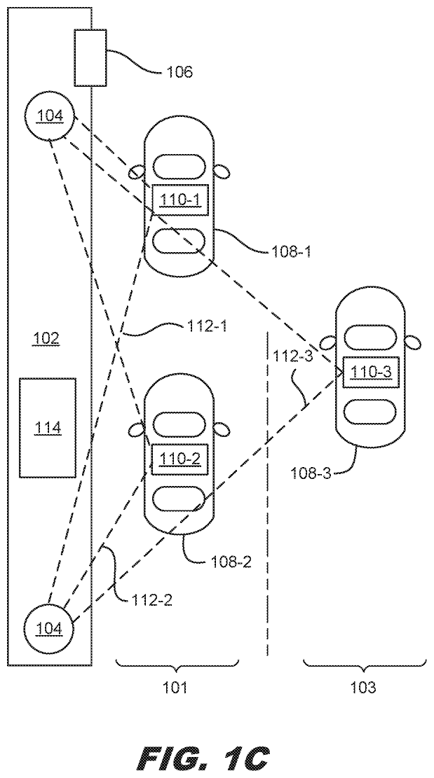

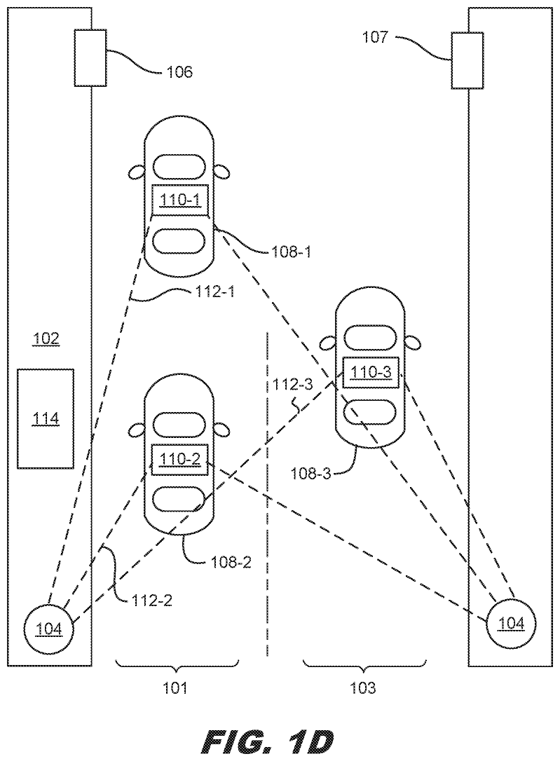

FIG. 1A is a diagram depicting wireless communication between a transponder 104 and vehicles 108-1, 108-2 in a drive-thru line 101. The drive-thru line 101 includes a pickup location 106 at a business location 102. The business location 102 may include a computing system 114 in communication with the transponder 104. Thus, the computing system 114 may process orders received over wireless connections 112-1, 112-2 to devices 110-1, 110-2 associated with the vehicles 108-1, 108-2.

In the present example, device 110-1 is associated with vehicle 108-1. Device 110-2 is associated with vehicle 108-2. In one example, the devices 110-1, 110-2 are onboard computing devices. Such devices may be integrated into the vehicles and provide vehicle occupants with a user interface through the console. For example, the vehicle's console may have a touchscreen that allows the user to interact with the device.

The onboard vehicle system may also have a custom application associated with the business location 102 installed thereon. For example, the business location 102 may be a chain restaurant that produces and makes a custom application available for download onto onboard vehicle computing systems. In some examples, the application may be a third-party generic application applicable to multiple types of businesses.

In one example, the application on the device 110-1 may interact with the business' computing system 114 over wireless connection 112-1 to receive ordering information. In the example where the business location 102 is a restaurant, the application may notify the restaurant of its proximity and request menu items for display to a user. The user may then select the desired menu items, enter payment information, and place an order. The application may thus transmit the order to the restaurant computing system 114 over the wireless connection 110-1.

In some examples, the computing device 110-1 may be a mobile device associated with an occupant of the vehicle. Such device may similarly connect with the business location computing system 114 over wireless connection 112-1. The mobile computing device may also use an application that is either proprietary to the business location 102 or generic to multiple business locations. The mobile device 110-1 may receive a list of items for sale and present those items to a user. The user may then select the desired items, enter payment information, and send the order to the business location.

The wireless connections 112-1, 112-2 over which orders may be transmitted may utilize one of several types of communication technologies. For example, the wireless connection may be either a Bluetooth connection, a Wi-Fi connection, or other short-range connection. In the example where the device 110-1 is an onboard computing system, the vehicle 108-1 may include the hardware for communicating over such technologies. In the example were the device 110-1 is a mobile device, the mobile device may include the hardware for communicating over such technologies. By using a short range wireless technology such as Bluetooth or Wi-Fi, it can be ensured that persons submitting orders are actually within proximity of the building.

The orders transmitted over the wireless connections 112-1, 112-2 may be received and processed by the business location computing systems 114. Since computing systems 114 may include, for example a server. The server may have machine-readable instructions thereon because the server to receive the orders and prioritize those orders based on a determine distance.

The distances may be determined in a variety of ways. For example, the wireless communication technology used for the wireless connections 112-1, 112-2 may have the ability to determine the distance between the transponder 104 and the devices 110-1, 110-2. It may be determined, for example, that the distance between the transponder 104 and device 110-1 is 12 feet. It may also be determined that the distance between the transponder 104 and the device 110-2, is approximately 30 feet. In such a case, the computing system 114 determines that vehicle 108-1 is closer to the transponder 104, and thus the pickup location 106 than vehicle 108-2. As a result, the computing system 114 may prioritize the order from vehicle 108-1 over the order from vehicle 108-2.

Various techniques may be used to estimate distance. For example, signal strength may be measured to estimate an approximate distance. In some examples, time-of-flight calculations may be used to estimate distance. In either case, the characteristics of the wireless connection 112-1 between the transponder 104 at the business location 102 and the device 110-1 is used to estimate distance.

In one example, prioritizing orders means that the orders are placed in a queue. The queued orders may be presented to employees at the business location 102 in the prioritized order. In other words, the employees may process the order from vehicle 108-1, before they process the order from vehicle 108-2. In the example where the business location 102 is a restaurant, the employees will make the food for vehicle 108-1 before they make the food for vehicle 108-2.

Using principles described herein, a driver may be able to pick up items at a drive-thru window without having to roll down the window until he or she is ready to pick up the item at the pickup window 106. Moreover, the business can efficiently prioritize multiple orders based on an automatic determination of the orders of the vehicles in the drive-thru line 101. Specifically, by utilizing the communication technology to detect the distance between the transponder 104 and the vehicles 108-1, 108-2, the order of the vehicles 108-1, 108-2 in the drive-thru line 101 may be determined. In the present example, the transponder 104 is placed near the pickup window 106. However, other configurations are contemplated as well.

FIG. 1B is a diagram depicting wireless communication between the transponder 104 and the vehicles 108-1, 108-2 in the drive-thru line 101 with the transponder 104 in a different location. In this example, the transponder 104 is not in the same location as the pickup location 106. In such an example, it may be determined that the distance between the transponder 104 and the device 110-1 of vehicle 108-1 is greater than the distance between the transponder 104 and the device 110-2 of vehicle 108-2. In some examples, there may be more than one transponder 104. Specifically, there may be two transponders that each establish a connection to the devices 110-1, 110-2 associated with the vehicles 108-1, 108-2. By having two transponders, additional accuracy of the placement of the vehicles 108-1, 108-2 may be realized. This may be particularly helpful in situations where there is more than one drive-thru line.

FIG. 1C is a diagram depicting wireless communication between transponders 104 and vehicles 108-1, 108-2, 108-3 in multiple drive-thru lines 101, 103 for a single pickup location 106. According to the present example, two transponders 104 may be used to help determine which drive-thru lines a particular vehicle is in. For example, it may be determined that vehicle 108-3 is in the second drive-thru line 103 and is positioned to move up to the pickup location 106 before vehicle 108-2. In such a case, the order for vehicle 108-3 may be prioritized over the order for vehicle 108-2. Examples in which there are more than one transponder 104 may also be used in situations where there are both multiple drive-thru lines and multiple pickup locations.

FIG. 1D is a diagram depicting wireless communication between transponders and vehicles 108-1, 108-2, 108-3 in multiple drive-thru lines 101, 103 for multiple pickup locations 106, 107. In the present example, the two transponders 104 may determine which drive-thru line each vehicle 108-1, 108-2, 108-3 and assign the orders from those vehicles to an appropriate queue. For example, the computing system 114 may put the orders from vehicles 108-1 and 108-2 into a first queue associated with pickup location 106. And, the computing system 114 may put the orders from vehicle 108-3 into a second queue associated with the second pickup location 107.

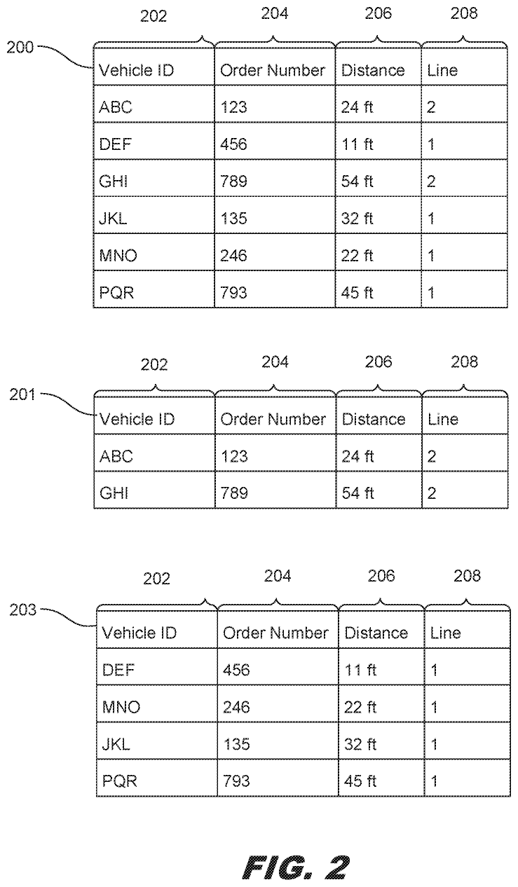

FIG. 2 is a set of tables illustrating the prioritization of orders based on vehicle location. FIG. 2 illustrates a first table 200 indicating a plurality of orders received from a plurality of vehicles. The table 200 includes a vehicle ID column 202, an order number column 204, a distance column 206, and a line column 208. Each row corresponds to a different order received from a different vehicle.

The values in the vehicle ID column 202 may be alphanumeric values that uniquely identify a particular vehicle. The vehicle ID may be assigned by the application running on the device (e.g., 110-1, 110-2, 110-3) that transmits the order. The vehicle ID may be either created by the user of the device or generated by the application.

The values in the order ID column 204 may be alphanumeric values that uniquely identify a particular order. The order ID may be assigned by the ordering application either on the client side (i.e., device 110-1, 110-2, 110-3) or on the server side (i.e., 114). The order ID may be used to reference the data that represents the items selected for purchase by the user of the client device.

The values in the distance column 206 may be numerical values indicating the distance between a transponder (e.g., 104) and the devices. In the present example, the transponder may be located near the pickup location. Thus, a greater distance value indicates that the vehicle is farther away from the pickup location (e.g., 106).

The value in the line column 208 may be an alphanumeric value that indicates which of a plurality of lines a particular vehicle is positioned in. The line column 208 may not be present in situations in which there is only one line. In some examples, additional transponders may be used to help determine which line a particular vehicle is positioned in.

As described above, the computing system (e.g., 114) may prioritize orders by placing them in different queues. In the example where there is a single line, a single queue may be used. In the example where there are two pickup locations, there may be two queues, one for each pickup location. In the present example, table 201 is associated with a queue for line 2 and table 203 is associated with a queue for line 1. As can be seen, the rows in tables 201, 203 have been rearranged so that the orders with less distance from the transponder are placed first.

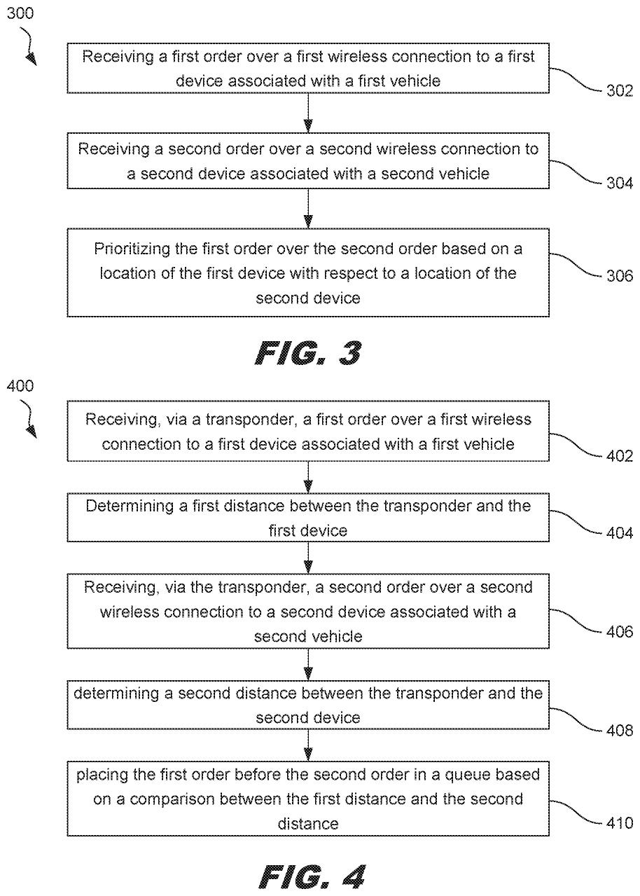

FIG. 3 is a flowchart showing an illustrative method 300 for prioritizing orders for vehicles in a drive-thru pickup line. In one example, the method 300 may be performed by a computing system (e.g., 114) associated with a business location (e.g., 102). The business location may be, for example, a restaurant, a dry cleaners, a pharmacy, or other business that provides a pickup window to customers.

According to the present example, the method 300 includes a process 302 for receiving a first order from a first device (e.g., 110-1) associated with a first vehicle (e.g., 108-1). In some examples, the first order may be received over a first wireless connection (e.g., 112-1). The computing system receiving the first order may be in communication with a transponder that facilitates the first wireless connection with the first device. In one example, the first device is an onboard computing system integrated with the first vehicle.

The method 300 further includes a process 304 for receiving a second order from a second device (e.g., 110-2) associated with a second vehicle (e.g., 108-2). In some examples, the second order may be received over a second wireless connection (e.g., 112-2). The second order may be received via the transponder, which facilitates the second wireless connection with the second device. In one example, the second device is an onboard computing system integrated with the second vehicle.

The method 300 further includes a process 306 for prioritizing the first order over the second order based on a location of the first device with respect to a location of the second device. In some examples, the locations of the first device and the second device may be determined based on the distance between the devices and the transponder. Such distances may be determined by utilizing the communication technology. Thus, the order from a vehicle closer to the pickup location may be prioritized over an order from a vehicle farther away from the pickup location.

In some examples, prioritizing the order involves placing the orders in a queue such that orders associated with vehicles that are closer to the pickup location are placed at the top of the queue. That queue may then be presented to employees at the business location so that those employees can prepare the orders more efficiently. Specifically, orders can be prepared such that the orders for vehicles closer to the pickup location are prepared first.

In some examples, if one car pulls in front of another car, such as in a case where two lines merge into one line before a pickup window, the orders for those vehicles can be rearranged in the queue. For example, the queue may originally have the order for vehicle 108-3 behind the order for vehicle 108-2. However, vehicle 108-3 may pull in front of vehicle 108-2 at a merge location. The computing system at the business location may continually or repeatedly check the distance between the transponder and the vehicles so as to detect the change in distance. Thus, the computing system may adjust the queue so that the order for vehicle 108-3 is ahead of the order for vehicle 108-2.

In some examples, the order may be received over the short-range wireless connections (e.g., 112-1, 112-2) while the devices 110-1, 110-2 are in range of the transponder. In some examples, the orders may be received over a different network such as the Internet before the devices 110-1, 110-2 are within range of the transponder. Then, when the devices 110-1, 110-2 come within range of the transponder, the distances between the transponder and the devices 110-1, 110-2 may be determined so that the orders can be prioritized appropriately.

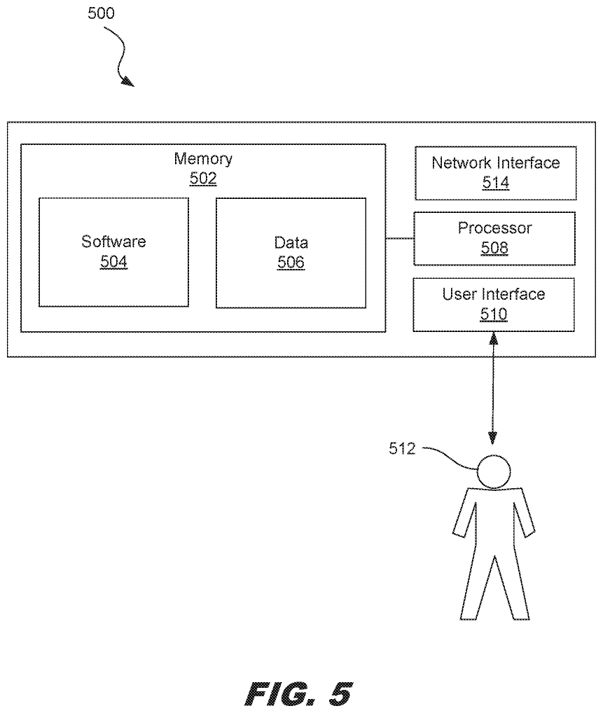

FIG. 4 is a flowchart showing an illustrative method for prioritizing orders for vehicles in a drive-thru pickup line. In one example, the method 400 may be performed by a computing system (e.g., 114) associated with a business location (e.g., 102). The business location may be, for example, a restaurant, a dry cleaners, a pharmacy, or other business that provides a pickup window to customers.

According to the present example, the method 400 includes a process 402 for receiving, via a transponder (e.g., 104), a first order over a first wireless connection (e.g., 112-1) to a first device (e.g., 110-1) associated with a first vehicle (e.g., 108-1). The computing system receiving the first order may be in communication with a transponder that facilitates the first wireless connection with the first device. In one example, the first device is an onboard computing system integrated with the first vehicle.

The method 400 further includes a process 404 for determining a first distance between the transponder and the first device. This distance may be an approximate distance that is determined using the wireless connection technology. In other words, determining the distance may be based on characteristics of the wireless connection. For example, determining distance may be done using time-of-flight measurements and/or signal strength measurements.

The method 400 further includes a process 406 for receiving, via the transponder, a second order over a second wireless connection (e.g., 112-2) to a second device (110-2) associated with a second vehicle (108-2). The second order may be received via the transponder, which facilitates the second wireless connection with the second device. In one example, the second device is an onboard computing system integrated with the second vehicle.

The method 400 further includes a process 408 for determining a second distance between the transponder and the second device. This distance may be an approximate distance that is determined using the wireless connection technology. For example, determining distance may be done using time-of-flight measurements and/or signal strength measurements.

The method 400 further includes a process 410 for placing the first order before the second order in a queue based on a comparison between the first distance and the second distance. For example, as shown in FIG. 2, orders may be placed into appropriate queues based on distance.

In some examples, before the order is transmitted from the first device or the second device, the computing system of the business location may transmit to the first device and the second device, data indicating a list of items for sale at the pickup location. For example, the data may include a menu. This data may then be presented on a GUI of the devices (e.g., 110-1).

In some examples, the sale of the ordered items may be transacted between an occupant of the vehicle through the device. For example, the occupant may provide credit card or other payment information through the device. That information may then be transmitted over the wireless connection (e.g., 112-1) to the business location computing system (i.e., an entity associated with the transponder).

FIG. 5 is a diagram showing an illustrative computing system that can be used for order management. In one example, the computing system may be, for example, a server (e.g., 114) associated with the business location. In one example, the computing system may be, for example, an onboard vehicle computing system or other computing device associated with a vehicle. According to certain illustrative examples, the physical computing system 500 includes a memory 502 having software 504 and data 506 stored thereon. The physical computing system 500 also includes a processor 508 and a user interface 510 (e.g., Graphical User Interface (GUI)).

There are many types of memory available. Some types of memory, such as solid-state drives, are designed for storage. These types of memory typically have large storage volume but relatively slow performance Other types of memory, such as those used for Random Access Memory (RAM), are optimized for speed and are often referred to as “working memory.” The various forms of memory may store information in the form of software 504 and data 506. The software 504 may include machine readable instructions for performing the processes described herein, such as the processes 300 or 400.

The physical computing system 500 also includes a processor 508 for executing the software 504 and using or updating the data 506 stored in memory 502. In addition to storing the software 504, the memory 502 may store an operating system. An operating system allows other applications to interact properly with the hardware of the physical computing system.

In the example where the physical computing system 500 corresponds to a server associated with the business location, the software 504 may include functions for transmitting menu items to vehicle devices. The software may also include functions for receiving orders from those vehicles. The software 504 may also include functions for determining the distances between the pickup location and the vehicles. The software 504 may also include functions for prioritizing the orders based on the distances.

In the example where the physical computing system 500 corresponds to an onboard vehicle computing system, the software 504 may include functions for receiving menu items and presenting those menu items to a user. The software 504 may also include functions for receiving selections from the user and transmitting those selections to the business location computing system. The software 504 may also include functions for transacting a sale of the ordered items.

A user interface 510 may provide a means for a user 512 to interact with the system. The user 512 may use various tools such as a touchscreen or physical buttons on the vehicle console to input information into the physical computing system. Additionally, various output devices such as a touchscreen or other display may be used to provide information to the user 512.

The physical computing system 500 further includes a network interface 514. The network interface 514 allows the computing system to communicate with other computing system. In the example where the physical computing system 500 corresponds to the audio setting processing system 110, the network interface 514 may be a hardwire network interface such as Ethernet or fiber optic. The network interface 514 may also be a wireless network interface. In the example where the physical computing system 500 corresponds to an onboard vehicle computing system, the network interface 514 may be for a cellular connection or a Wi-Fi connection, Bluetooth connection, or UWB connection.

Although various embodiments and methods have been shown and described, the disclosure is not limited to such embodiments and methods and will be understood to include all modifications and variations as would be apparent to one skilled in the art. Therefore, it should be understood that embodiments of the disclosure are not intended to be limited to the particular forms disclosed. Rather, the intention is to cover all modifications, equivalents and alternatives falling within the spirit and scope of the disclosure as defined by the appended claims.

What is claimed is:

1. A method performed by a computing system, the method comprising:
receiving, via a transponder, a first order over a first wireless connection to a first device associated with a first vehicle;
determining a first distance between the transponder and the first device;
receiving, via the transponder, a second order over a second wireless connection to a second device associated with a second vehicle;
determining a second distance between the transponder and the second device; and
placing the first order before the second order in a queue based on a comparison between the first distance and the second distance.

2. The method of claim 1, wherein the first wireless connection comprises a Bluetooth connection.

3. The method of claim 1, wherein the first wireless connection comprises a Wi-Fi connection.

4. The method of claim 1, wherein the first device is embedded in the first vehicle.

5. The method of claim 1, wherein the comparison indicates that the first vehicle is closer to a pickup location than the second vehicle.

6. The method of claim 5, further comprising, transmitting to the first device and the second device, data indicating a list of items for sale at the pickup location.

7. The method of claim 6, wherein the first device includes a Graphical User Interface (GUI) to present the list of items to an occupant of the first vehicle.

8. The method of claim 1, further comprising, transacting a sale through the first device and an entity associated with the transponder.

9. The method of claim 1, wherein the queue is one of a plurality of queues, each queue associated with a different pickup location.

10. The method of claim 9, wherein the queue is selected from among the plurality of queues based on locations of the first vehicle and the second vehicle.

11. A method performed by a computing system, the method comprising:
receiving a first order from a first device associated with a first vehicle;
receiving a second order from a second device associated with a second vehicle; and
prioritizing the first order over the second order based on a location of the first device determined from a first wireless connection between a transponder and the first device with respect to a location of the second device determined from a second wireless connection between the transponder and the second device.

12. The method of claim 11, further comprising, determining the location of the first device based a characteristic of the first wireless connection.

13. The method of claim 11, wherein the prioritizing comprises placing the first order ahead of the second order in a queue.

14. The method of claim 13, further comprising, with the computing system, presenting the queue to a user.

15. The method of claim 11, further comprising, assigning the first order to one of a plurality of queues based on the location of the first device.

16. The method of claim 11, further comprising, rearranging the queue in response to determining a change in the location of the first device and the location of the second device.

17. The method of claim 11, wherein the location of the first device is determined based on a distance between a transponder and the first device.

18. A system comprising:
a processor; and
a memory comprising machine readable instructions that when executed by the processor, cause the system to:
transmit, over wireless connections, data to a plurality of computing devices, each of the plurality of computing devices associated with a different one of a plurality of vehicles;
receive, from the plurality of computing devices, a plurality of orders, each of the plurality of orders being for a specific one of the plurality of vehicles;
use the wireless connections to determine locations of each of the computing devices; and
queue the orders based on the locations of each of the computing devices such that orders associated with vehicles closer to a pickup location are placed before orders associated with vehicles farther from the pickup location.

19. The system of claim 18, wherein the wireless connections include one of: Bluetooth, Ultra-wideband (UWB) and Wi-Fi.

20. The system of claim 18, wherein the data includes a list of items for sale for pickup at the pickup location.
